(19) United States
(12) Patent Application Publication
(10) Pub. No.: US 2026/0339568 A1
(43) Pub. Date: Oct. 29, 2026

(54) FREE BLOCK THRESHOLD ADJUSTMENT BY WRITE CURSORS

(71) Applicant: Micron Technology, Inc., Boise, ID (US)

(72) Inventors: Kevin R. Brandt, Boise, ID (US); Brent Carl Byron, Boise, ID (US)

(21) Appl. No.: 19/655,189

(22) Filed: Apr. 22, 2026

Related U.S. Application Data
(60) Provisional application No. 63/793,242, filed on Apr. 23, 2025.

(51) Int. Cl. G06F 3/06

(52) U.S. Cl. CPC G06F 3/0659; G06F 3/0604; G06F 3/0679

(57) ABSTRACT

A memory system includes a memory device with multiple physical regions and a processing device. The processing device receives a command from a host system to control physical locations where data is stored. It determines the number of write cursors specified in the command and adjusts a free block threshold for the memory device accordingly. Based on the adjusted threshold, the processing device reserves a set of block stripes on the memory device to ensure that data can be efficiently written to the memory.

### PRIORITY APPLICATION

This application claims the benefit of priority to U.S. Provisional Application Ser. No. 63/793,242, filed Apr. 23, 2025, which is incorporated herein by reference in its entirety.

### TECHNICAL FIELD

This disclosure relates generally to memory sub-systems and, more specifically, to providing adaptive free block management for flexible data placement (FDP) compliant memory components, such as memory dies.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components. Some memory sub-systems are FDP compliant and arrange their memory components into reclaim groups (RGs), each of which includes sets of reclaim units (RUs). Such memory sub-systems enable a host to control the physical location (e.g., by RG and/or RU via an RU handle (also referred to as a write cursor)) into which data is programmed.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing environment including a memory sub-system, in accordance with some examples.

FIG. 2 is a block diagram of an example media operations manager, in accordance with some examples.

FIG. 3 is a block diagram of an example FDP system implementation of the memory sub-system, in accordance with some examples.

FIG. 4 illustrates a diagram of operations performed to transition the memory device into an FDP mode, in accordance with some examples.

FIG. 5 illustrates a diagram of operations performed using the media operations manager, in accordance with some examples.

FIG. 6 illustrates a diagram of operations performed using the media operations manager, in accordance with some examples.

FIG. 7 is a block diagram of an example computer system, in accordance with some examples.

### DETAILED DESCRIPTION

Examples of the present disclosure provide a system for optimizing memory resource allocation in FDP-compliant memory sub-systems. The system dynamically adjusts the free block threshold based on the actual number of write cursors (RU handles) selected or activated by the host system, rather than reserving block stripes for the maximum possible number of write cursors. When FDP is activated, the system determines the number of write cursors requested by the host and sets the free block threshold accordingly, reserving only the necessary number of block stripes. For example, if the host activates only one write cursor, the system maintains the default threshold without reserving additional blocks. Alternatively, if the host activates multiple write cursors, the system reserves only the additional blocks needed for those specific cursors. This approach prevents unnecessary over-provisioning, optimizes the write amplification factor (WAF), and improves overall system efficiency by freeing up memory resources that would otherwise be trapped when reserving for the maximum possible number of write cursors.

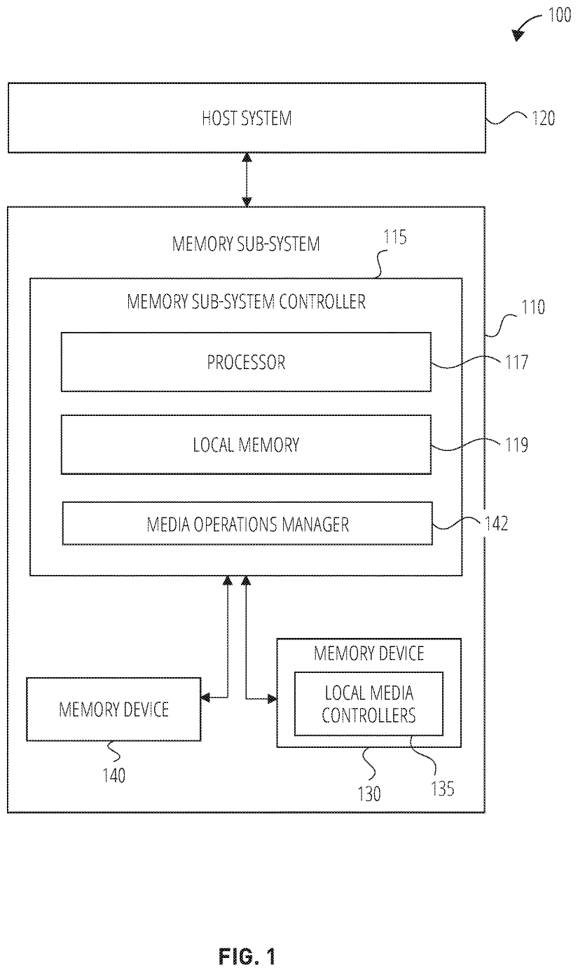

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices (e.g., memory dies or planes across multiple memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data.”

In some cases, the memory sub-system includes an optional feature, such as an FDP feature that defines RGs and RUs. This protocol enables remote hosts to control data storage on the memory sub-systems. Some memory sub-systems define or generate virtual memory groups, such as virtual RUs. These virtual memory groups can be implemented by multiple different physical memory components and/or portions of physical memory components. By defining virtual memory groups, the data block size available to a host to store data can be kept constant across different technologies of memory sub-systems and as different portions of various blocks reach their end of life, such as when they reach their maximum PECs.

The memory sub-system can initiate media management operations, such as a write operation, on host data that is stored on a memory device. For example, firmware of the memory sub-system may rewrite previously written host data from a location on a memory device to a new location as part of garbage collection management operations. The data that is rewritten, for example as initiated by the firmware, is hereinafter referred to as “garbage collection data.” “User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management, different near miss error correction coding (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area that can be erased. Such blocks can be referred to or addressed as logical units (LUN). Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are raw memory devices combined with local embedded controllers for memory management within the same memory device package.

Certain FDP-compliant memory systems group the physical memory components into different RGs where each RG includes multiple RUs. The RUs can be of any size that is at least as large as the LUN. Namely, the RU can be the size of a single block or a block stripe (BS; e.g., can be the size of a superblock spanning multiple memory dies). In some cases, each RU and/or RG can correspond to and be implemented by a different SSD. These memory systems allow hosts to store data to certain RGs and/or to certain RUs within those RGs using corresponding RU handles (write pointers or write cursors). This provides greater control to the host as to where data is physically stored. Once data is stored to an individual RG, garbage collection operations can be performed but are limited to folding data using the RUs of the individual RG. Namely, in some cases, data cannot be folded into any RU or another RG, but all remains stored in the same RG.

Conventional memory systems that implement FDP suffer from significant inefficiencies in their resource allocation strategies, particularly in how they manage free block thresholds for garbage collection operations. These systems organize physical memory components into RGs, with each RG containing multiple RUs that can be accessed using write cursors or RU handles. While this organization provides hosts with greater control over data placement, it introduces substantial overhead in memory resource management. In solid-state drives (SSDs), a minimum number of block stripes (e.g., base blocks) are usually reserved for emergency operations in a non-FDP configuration or non-FDP mode. These base blocks are used for critical garbage collection operations that maintain the drive's functionality even when it reaches capacity limits.

The default free block threshold is set to accommodate these emergency operations. In a standard non-FDP configuration, this threshold can be set to, for example, six block stripes (or one or more individual blocks or multiple memory blocks grouped together). This threshold number of block stripes or individual blocks represents the minimum number of free blocks that may need to be maintained at all times to handle emergency cases such as power loss or program status failures. When this threshold is reached, the drive initiates “Critical Garbage Collection” (CGC), which deprioritizes host traffic to ensure the required number of free block stripes is maintained. This default threshold is established at “time zero” when the drive is in its initial state with FDP not enabled. At this point, the system assumes a default configuration with typically just one host write cursor. The threshold is designed to provide sufficient emergency space for this single write cursor scenario.

When FDP is activated in conventional systems, the firmware immediately reserves additional block stripes on top of these 6 base blocks. For example, one additional block stripe for each potential write cursor (RUH) that the drive could support, regardless of how many RUH will actually be used. So, in a system with eight RUH support, the system reserves 14 block stripes (six base blocks+eight additional blocks), even if the host only activates a single RUH. The inefficiency arises because these reserved blocks become unavailable for normal operations, effectively reducing the usable over-provisioning space. This trapped over-provisioning directly increases the write amplification factor (WAF) as the system has fewer blocks available for normal write operations, forcing more frequent garbage collection cycles. The problem compounds with higher numbers of supported RUHs. For example, with a 16 RUH support, the system would reserve 22 block stripes (six base blocks plus 15 or 16 additional block stripes), severely impacting performance if only a few RUHs are actually used.

Examples of the present disclosure address the above and other deficiencies by providing a system that dynamically adjusts the free block threshold based on the actual number of write cursors specified by the host system, rather than reserving block stripes for the maximum possible number of write cursors. When a command to enable FDP is received, the system determines the number of write cursors requested by the host and sets the free block threshold accordingly, reserving only the necessary number of block stripes. In some cases, the number of RUHs can be determined during namespace creation via a namespace management command which can take place after the FDP enable set feature is sent from the host system. In one example, if the host activates only one write cursor, the system maintains the default threshold (e.g., six free block stripes) without reserving additional blocks. However, if the host activates multiple write cursors, the system reserves the base blocks (e.g., six free block stripes but in some cases the base blocks can be a single memory block) and only the additional blocks needed for those specific cursors. This approach prevents unnecessary over-provisioning, optimizes the WAF, and improves overall system efficiency by freeing up memory resources that would otherwise be trapped when reserving for the maximum possible number of write cursors.

The term “free block threshold” is a system parameter in memory sub-systems that defines the minimum number of block stripes that need to be maintained as available (free) at all times to handle emergency operations such as power loss or program status failures. The free block threshold serves as a reserve of memory resources that ensures the system can perform essential operations even when the memory device approaches capacity limits. In a standard non-FDP configuration, this threshold can be set to a specified number of blocks or block stripes, such as six block stripes, representing the minimum number needed for emergency operations with a single write cursor. In an FDP mode, the default value of the free block threshold can be increased or adjusted based on the total number of RUH specified in a command to transition to the FDP mode, such as when creating namespaces while in FDP mode. The free block threshold can be set in terms of one or more individual memory blocks and/or one or more individual block stripes. Any mention of free block threshold refers to one or more individual memory blocks and/or one or more individual block stripes.

In some examples, a memory system is provided that includes a memory device including a plurality of memory components organized into a plurality of physical regions and a processing device, coupled to the memory device. The processing device can be programmed to perform operations including receiving, from a host system, a command to enable a feature that allows the host system to control physical locations where data is stored in the memory device. The processing device determines a number of write cursors specified by the command and, in response to receiving the command from the host system, adjusts a free block threshold for the memory device based on the determined number of write cursors. The processing device then reserves a set of block stripes on the memory device corresponding to the free block threshold.

The memory device may include a FDP-compliant storage device. When the memory device is operated in a non-FDP mode where the feature is disabled, the processing device sets the free block threshold to a default number of free block stripes. Upon transitioning the memory device to be operated in an FDP mode where the feature is enabled in response to the command, the processing device determines an amount by which to increase the free block threshold based on the determined number of write cursors. This transition may involve deleting all data on the memory device.

The processing device can group the plurality of memory components into a plurality of RGs, each RG comprising a subset of RUs, where the number of write cursors includes a number of RUHs. When receiving a namespace creation command that specifies the number of write cursors, the processing device determines the number of RGs to create based on the command and allocates the RUs to each RG based on the specified number of write cursors. If the number of RUHs in the command is equal to one, the processing device maintains the free block threshold at a default value. However, if the number of RUHs in the command is greater than one, the processing device calculates an additional number of free block stripes to reserve based on the determined number of RUHs and adjusts the free block threshold to include the additional number of free block stripes. The additional number of free block stripes can include one less block stripe than the number of RUHs in the command.

The processing device can receive a subsequent command to create an additional RUH, adjust the free block threshold based on this command, and reserve an additional block stripe in the memory device corresponding to the adjusted free block threshold. The processing device may also monitor a WAF of the memory device, determine if the WAF exceeds a threshold value, and dynamically adjust the free block threshold to optimize the WAF based on actual usage patterns of the write cursors.

When receiving a command to enable persistent isolation for a plurality of RGs, the processing device may optionally determine that persistent isolation requires additional reserved block stripes. In such cases, the processing device further adjusts the free block threshold to accommodate this requirement. Persistent isolation involves maintaining data separation between RUs by preventing garbage collection operations from relocating data from one RU to another RU within an RG. This can include allocating a dedicated garbage collection cursor for each RU in the RG to manage valid data within its respective RU. The processing device may need to reserve additional free block stripes beyond the free block threshold corresponding to the determined number of write cursors to support the dedicated garbage collection operations. Persistent isolation ensures that data isolation boundaries between RUs are maintained during all memory management operations to ensure data from different write cursors remains physically separated.

The processing device can track actual usage statistics of each write cursor, identify inactive write cursors, and dynamically reduce the free block threshold based on the identified inactive write cursors. Additionally, the processing device determines that the memory device supports a maximum possible number of write cursors, compares the determined number of write cursors to the maximum possible number, and reserves only the number of free block stripes corresponding to the determined number rather than the maximum possible number. The memory device may comprise a three-dimensional (3D) NAND device.

Though various examples are described herein as being implemented with respect to a memory sub-system (e.g., a controller of the memory sub-system), some or all of the portions of an embodiment can be implemented with respect to a host system, such as a software application or an operating system of the host system.

FIG. 1 illustrates an example computing system 100 including a memory sub-system 110, in accordance with some examples of the present disclosure. The memory sub-system 110 can include media, such as memory device 130 and memory device 140 (also hereinafter referred to as “memory devices” or “memory components”). The memory device 130 and memory device 140 can be volatile memory devices, non-volatile memory devices, or a combination of such. The memory device 130 and memory device 140 can be implemented by individual dies, such that a first memory device 130 can be implemented by a first memory die (or a first collection of memory dies) and a second memory device 140 can be implemented by a second memory die (or a second collection of memory dies). Each memory die can include a plurality of planes in which data can be stored or programmed. In some cases, the first memory device 130 can be implemented by a first SSD (or a first independently operable memory sub-system) and the second memory device 140 can be implemented by a second SSD (or a second independently operable memory sub-system).

In some examples, one of the memory device 130 and memory device 140 can be associated with a first RG and another one of the memory device 130 and memory device 140 can be associated with a second RG. In some cases, a first portion (e.g., a first BS) or first memory block) of the memory device 130 and memory device 140 can be associated with a first RU of the first RG and a second portion (e.g., a second BS or second memory block) of the memory device 130 and memory device 140 can be associated with a second RU of the second RG. The memory sub-system 110 can have any number of RGs and any number of RUs within each RG and can, in some cases, implement the FDP. In some cases, each RG can include a different number or different maximum number of RUs. Once that maximum number is reached, garbage collection operations can be initiated.

In some examples, a memory or register can be associated with all of the memory device 130 and memory device 140 and can store a table that maps portions of the memory device 130 and memory device 140 to different groups of RGs. The table can specify which set of memory device 130 and memory device 140 maps to or is associated and grouped with a first RG, and within that set, which portions of the memory device 130 and memory device 140 correspond to RUs within the first RG. Similarly, the table can specify which other set of memory device 130 and memory device 140 maps to or is associated and grouped with a second RG, and within that set, which portions of the memory device 130 and memory device 140 correspond to RUs within the second RG. In some cases, the table stores a list of LBAs associated with each RU.

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing system 100 can include a host system 120 that is coupled to a memory system. The memory system can include one or more memory sub-systems 110. In some examples, the host system 120 is coupled to different types of a memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory device 130 and memory device 140 when the memory sub-system 110 is coupled with the host system 120 by the PCIe or CXL interface. The physical host interface can provide an interface for passing control, address, data, and other signals between the memory sub-system 110 and the host system 120.

The memory device 130 and memory device 140 can include any combination of the different types of non-volatile memory components and/or volatile memory components and/or storage devices. An example of non-volatile memory components includes a negative-and (NAND)-type flash memory. Each of the memory device 130 and memory device 140 can include one or more arrays of memory cells such as single-level cells (SLCs) or multi-level cells (MLCs) (e.g., TLCs or QLCs). In some examples, a particular memory device 130 can include both an SLC portion and an MLC portion of memory cells. Each of the memory cells can store one or more bits of data (e.g., blocks) used by the host system 120. Although non-volatile memory components such as NAND-type flash memory are described, the memory device 130 and memory device 140 can be based on any other type of memory, such as a volatile memory. In some examples, the memory device 130 and memory device 140 can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells.

A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory device 130 and memory device 140 can be grouped as memory pages or blocks that can refer to a unit of the memory device 130 used to store data. For example, a single first row that spans a first set of the pages or blocks of the memory device 130 and memory device 140 can correspond to or be grouped as a first block stripe (BS and a single second row that spans a second set of the pages or blocks of the memory device 130 and memory device 140 can correspond to or be grouped as a second block stripe (BS).

The memory sub-system controller 115 can communicate with the memory device 130 and memory device 140 to perform memory operations such as reading data, writing data, or erasing data at the memory device 130 and memory device 140 and other such operations. The memory sub-system controller 115 can communicate with the memory device 130 and memory device 140 to perform various memory management operations, such as different scan rates, different scan frequencies, different wear leveling, different read disturb management, garbage collection operations, different near miss ECC operations, and/or different dynamic data refresh.

The memory sub-system controller 115 can include hardware, such as one or more integrated circuits and/or discrete components, a buffer memory, or a combination thereof. The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor 117 (processing device) configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example of the present disclosure, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory device 130 and memory device 140. In some examples, the commands or operations received from the host system 120 can specify configuration data for the memory device 130 and memory device 140. The configuration data can describe the lifetime (maximum) PEC values and/or reliability grades associated with different groups of the memory device 130 and memory device 140 and/or different blocks within each of the memory device 130 and memory device 140 and/or different RUs, and/or different RGs and/or sizes of storage regions (e.g., RUs, RGs, and/or blocks) of each memory component used to implement the memory sub-system.

For example, the memory sub-system 110 may be made up of three memory components (e.g., three SSDs). A first of the three memory components may be configured to store data in a first set of regions each being a first size; a second of the three memory components may be configured to store data in a second set of regions each being a second size; and a third of the three memory components may be configured to store data in a third set of regions each being a third size. The first, second, and third sizes can be equal or non-equal. The configuration data can specify the sizes of the set of regions of each of the memory components.

In some examples, commands or operations received from the host system 120 can include a write command, which can specify or identify an individual RG and/or RU within the individual RG to which to program data. Based on the individual RG specified by the write command, the memory sub-system controller 115 can determine the memory device 130 and memory device 140 associated with the individual RG and can generate a write pointer (RU handle) that is used to program the data to the determined memory device 130 and memory device 140. In some cases, the host system 120 can select an individual RU handle and can program data using the selected individual RU handle.

Each RG can be associated with a different RU handle (or write pointer). For example, a first RG can use a first write pointer (first RU handle) to program data into a first set of RUs of the first RG and a second RG can use a second write pointer (second RU handle) to program data into a second set of RUs of the second RG. Any data that is written by the host system 120 using the individual RU handle can be stored to a specified RU that is associated with the RU handle. Based on which RU handle is used by the host system 120 to program data, different RUs are used by the host system 120 to physically store the data simultaneously. In some cases, the host system 120 can track which LBAs are associated with which RU handles and can determine, based on the LBAs, the RUs in which the data is stored.

In some examples, the commands or operations received from the host system 120 can include a write command, which can specify or identify an individual virtual memory group in which to program data. Based on the virtual memory group specified by the write command, the memory sub-system controller 115 can determine the memory device 130 and memory device 140 (e.g., the RUs, LBAs, and/or RGs) associated with the virtual memory group and can program the data into the determined memory device 130 and memory device 140. In some cases, the host system 120 can select an individual virtual memory group to invalidate and can issue an invalidate command to the memory sub-system controller 115 identifying the individual virtual memory group. In response, the memory sub-system controller 115 can identify a list of memory device 130 and memory device 140 (e.g., one or more RUs and/or RGs) that are used to store the data for the individual virtual memory group. The memory sub-system controller 115 can then find the valid data in the list of memory device 130 and memory device 140 that belong to another virtual memory group. The memory sub-system controller 115 can then rewrite the found valid data from the other virtual memory group to a different memory device 130 to memory device 140.

The memory sub-system controller 115 can be responsible for other memory management operations, such as wear leveling operations, garbage collection operations, error detection and error-correcting code (ECC) operations, encryption operations, caching operations, and address translations. The memory sub-system controller 115 can further include host interface circuitry to communicate with the host system 120 via the physical host interface. The host interface circuitry can convert the commands received from the host system 120 into command instructions to access the memory device 130 and memory device 140 as well as convert responses associated with the memory device 130 and memory device 140 into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory device 130 and memory device 140.

The memory devices can be raw memory devices (e.g., NAND), which are managed externally, for example, by an external controller (e.g., memory sub-system controller 115). The memory devices can be managed memory devices (e.g., managed NAND), which are raw memory devices combined with local embedded controllers (e.g., local media controllers) for memory management within the same memory device package. Any one of the memory device 130 and memory device 140 can include a media controller (e.g., local media controllers 135) to manage the memory cells of the memory component (e.g., to perform one or more memory management operations), to communicate with the memory sub-system controller 115, and to execute memory requests (e.g., read or write) received from the memory sub-system controller 115.

The memory sub-system controller 115 can include a media operations manager 142. The media operations manager 142 can be configured to use the same RU handle or write cursor to program new data received from the host system 120 as that which is used to relocate previously programmed data in a particular RG (e.g., a set of regions). Specifically, the media operations manager 142 can program the data to each region of different sets of physical regions (e.g., RGs) using a respective write cursor (e.g., RU handle). In response to determining that garbage collection operations are needed for an individual set of regions (e.g., when a maximum number of regions have been programmed in the individual set of regions), the media operations manager 142 can relocate valid data from a second portion of the individual set of regions to a first portion of the individual set of regions using a first write cursor being used to program new data to the first portion. In this way, rather than using two different write cursors for programming and for performing data relocation, a single write cursor can be utilized which reduces the overall amount of resources consumed by the memory sub-system 110. This improves and increases the overall efficiency of operating the memory sub-system 110.

In some examples, the media operations manager 142 implements a sophisticated dual-mode operation strategy for managing free block thresholds in both non-FDP and FDP modes. In non-FDP mode, the media operations manager 142 maintains a default free block threshold of, for example, six free block stripes. The default free block threshold of, for example, six block stripes, represents the minimum number of free block stripes that need to be maintained at all times to handle emergency operations such as power loss or program status failures. When this default free block threshold is reached, the system initiates CGC, which deprioritizes host system 120 traffic to ensure the required number of free block stripes is maintained. This default threshold is established at “time zero” when the memory sub-system 110 is in its initial state with FDP not enabled, assuming a default configuration with just one host write cursor.

When transitioning to FDP mode, the media operations manager 142 takes a fundamentally different approach compared to conventional systems. Upon receiving a command from the host system 120 to enable the FDP mode on the memory sub-system 110, the media operations manager 142 examines the command to determine the exact number of write cursors (RU handles) requested by the host system 120. Instead of immediately reserving free block stripes for the maximum possible number of write cursors (which could be 8 or 16 depending on system capabilities), the media operations manager 142 dynamically adjusts the free block threshold based on the actual number specified.

For example, if the host system 120 activates only one write cursor, the media operations manager 142 maintains the default threshold of six free block stripes without reserving any additional blocks. This is because the default threshold is already designed to accommodate a single write cursor scenario. However, if the host system 120 activates multiple write cursors (e.g., 4 RUHs), the media operations manager 142 reserves the six base blocks plus only the additional blocks needed for those specific cursors (e.g., 3 additional blocks for a total of 9).

This intelligent approach prevents unnecessary over-provisioning that would occur in conventional systems, which might reserve 14 block stripes (6 base+8 additional) even when only one RUH is active. By reserving only what is needed, the media operations manager 142 optimizes the WAF and improves overall system efficiency by freeing up memory resources that would otherwise be trapped. The system can further adjust this threshold if the host later creates additional write cursors or enables features like persistent isolation that require additional reserved blocks.

Depending on the example, the media operations manager 142 can comprise logic (e.g., a set of transitory or non-transitory machine instructions, such as firmware) or one or more components that causes the media operations manager 142 to perform operations described herein. The media operations manager 142 can comprise a tangible or non-tangible unit capable of performing operations described herein. Further details with regards to the operations of the media operations manager 142 are described below. Any operation performed by the memory device 140 can similarly be performed by the memory device 130 and vice versa.

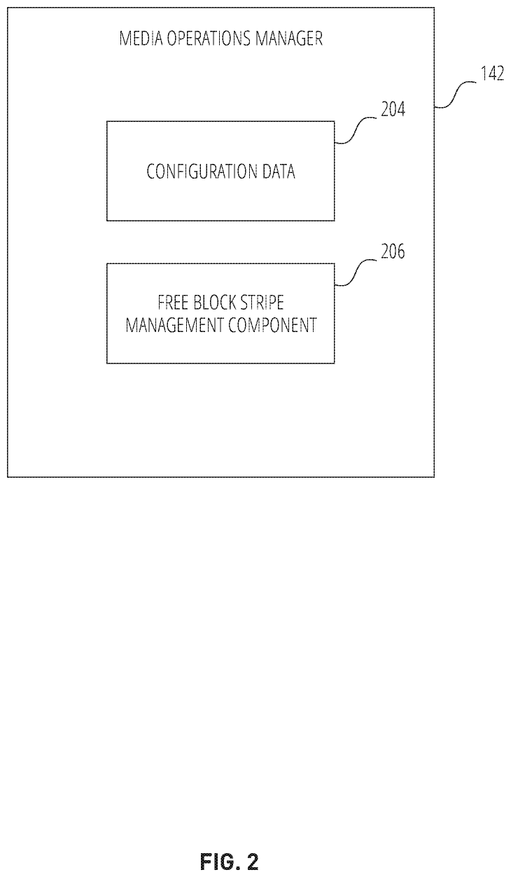

FIG. 2 is a block diagram of an example media operations manager 142, in accordance with some implementations of the present disclosure. As illustrated, the media operations manager 142 includes configuration data 204 and a free block stripe management component 206. For some examples, the media operations manager 142 can differ in components or arrangement (e.g., fewer or more components) from what is illustrated in FIG. 2.

The configuration data 204 accesses and/or stores configuration data associated with the memory device 130 and memory device 140 of FIG. 1. In some examples, the configuration data 204 is programmed into the media operations manager 142. For example, the media operations manager 142 can communicate with the memory device 130 and memory device 140 to obtain the configuration data and store the configuration data 204 locally on the media operations manager 142. In some examples, the media operations manager 142 communicates with the host system 120 of FIG. 1. The host system 120 receives input from an operator or user that specifies parameters including virtual memory group assignments to physical memory components, lifetime (maximum) PEC values of different bins, groups, blocks, block stripes, memory dies, RUs, RGs, and/or sets of the memory device 130 and memory device 140, default free block threshold for a non-FDP mode of the memory sub-system 110, and/or group assignments that define the sizes of different RU and RGs or regions of the memory components used to store data. The media operations manager 142 can receive configuration data from the host system 120 and stores the configuration data in the configuration data 204. In some cases, the media operations manager 142 accesses region size information from each of the memory components used to store data in the memory sub-system 110 of FIG. 1 and can communicate that information to the host system 120.

The configuration data 204 can store a map that identifies which sets of memory device 130 and memory device 140 are used to implement different RGs. The configuration data 204 can store a table that maps different virtual memory groups to different physical memory device 130 and memory device 140 (e.g., different RUs, RGs, and/or LBAs). For example, the configuration data 204 can store a map that associates a first RG with a first portion of the memory device 130 and memory device 140 (e.g., a first die or first set of LBAs) and that associates a second RG with a second portion of the memory device 130 and memory device 140 (e.g., a second die or second set of LBAs). The configuration data 204 can store a table that associates a first virtual memory group with a first portion of the memory device 130 and memory device 140 (e.g., a first die, a first portion of a first RU) and that associates a second virtual memory group with a second portion of the memory device 130 and memory device 140 (e.g., a second die or second portion of the first RU and a first portion of a second RU). The map can store an indication of the physical addresses or LUN of the first portion of the memory device 130 and memory device 140 associated with the first RG and/or virtual memory group and an indication of the physical addresses or LUN of the second portion of the memory device 130 and memory device 140 associated with the second RG and/or virtual memory group.

The free block stripe management component 206 is an important element of the media operations manager 142 that implements the dynamic adjustment of free block thresholds based on actual write cursor usage. In some cases, the free block stripe management component 206 is designed to perform garbage collection operations for each reclaim group (RG) in an efficient manner. The free block stripe management component 206 monitors the memory device 130 and memory device 140 to determine when garbage collection operations should be triggered, such as when an individual RG has reached a maximum number of RUs in which data has been programmed or when other conditions have been met.

When a command to enable FDP is received from the host system 120, the free block stripe management component 206 analyzes the command to determine the exact number of write cursors (RU handles) requested by the host system 120. Unlike conventional implementations that immediately reserve block stripes for the maximum possible number of write cursors, the free block stripe management component 206 dynamically adjusts the free block threshold based on the actual number specified. For non-FDP mode, the free block stripe management component 206 maintains a default free block threshold, specified by the configuration data 204, which represents the minimum number needed for emergency operations. When transitioning to FDP mode, the free block stripe management component 206 examines the command parameters to determine how many write cursors are being activated.

If the host system 120 activates only one write cursor, the free block stripe management component 206 maintains the default threshold (e.g., six free block stripes) without reserving any additional blocks. However, if the host system 120 activates multiple write cursors (e.g., 4 RUHs), the free block stripe management component 206 reserves the base blocks (specified in the configuration data 204, such as six free block stripes) plus only the additional block stripes needed for those specific cursors (e.g., 3 additional block stripes for a total of 9).

For systems supporting persistent isolation, the free block stripe management component 206 implements additional logic that goes beyond the standard free block threshold adjustments. In a standard FDP implementation, garbage collection operations can relocate data from one RU to another RU within the same reclaim group, but with persistent isolation enabled, this data movement is restricted, where data from one RU cannot be relocated to another RU. This creates a significant challenge for garbage collection operations that can require the memory sub-system 110 to allocate a dedicated garbage collection cursor for each RU in the reclaim group.

For instance, if a reclaim group has 8 RUs with persistent isolation enabled, the memory sub-system 110 needs eight dedicated garbage collection cursors, such as one for each RU, with each cursor requiring its own reserved block stripe to ensure it can perform garbage collection operations within its isolated domain. When persistent isolation is enabled, the memory sub-system 110 also needs additional block stripes to handle emergency recovery scenarios. For example, if a power loss occurs during a write operation to a specific RU, the system needs a dedicated recovery block for that specific RU, whereas in a non-persistent isolation scenario, any available block could be used for recovery.

With persistent isolation, garbage collection operations may occur independently within each RU, meaning that if multiple RUs are approaching capacity simultaneously, the memory sub-system 110 may need to be able to perform parallel garbage collection operations while maintaining isolation. For example, if 4 different RUs are simultaneously reaching their capacity limits, the memory sub-system 110 needs 4 separate reserved block stripes to handle the parallel garbage collection operations without violating the isolation boundaries between RUs. The need for additional free block stripes beyond the base blocks plus RUH specified in the command to enable the FDP mode stems from the operations of persistent isolation. These involve maintaining strict data separation between RUs by preventing garbage collection operations from relocating data from one RU to another RU within a reclaim group, requiring each RU to have its own dedicated space for garbage collection. Each RU in the RG requires its own dedicated garbage collection cursor to manage valid data within its respective RU, with these dedicated cursors each needing their own reserved block stripe. The memory sub-system 110 may need to maintain data isolation boundaries between RUs during all memory management operations to ensure data from different write cursors remains physically separated, including emergency operations, recovery procedures, and normal garbage collection. With persistent isolation, each RU effectively becomes its own independent resource management domain, requiring additional overhead in terms of reserved blocks to ensure each domain can operate without affecting others.

For example, in a standard non-FDP configuration, the memory sub-system 110 maintains a default free block threshold of, for example, 6 block stripes, for emergency operations. When transitioning to FDP mode without persistent isolation, the memory sub-system 110 adjusts the free block threshold based solely on the number of write cursors (RUHs) specified by the host system 120. Namely, with 8 RUHs without persistent isolation, the memory sub-system 110 can reserve 14 block stripes (6 base blocks+8 additional block stripes). However, with persistent isolation enabled for those same 8 RUHs, the memory sub-system 110 may need to reserve significantly more, potentially up to 22 block stripes (6 base blocks+8 RUH based blocks+8 blocks for dedicated garbage collection cursors). Similarly, in a system supporting 16 RUHs, without persistent isolation, the free block threshold can be 22 block stripes (6 base blocks+16 RUH based blocks). With persistent isolation enabled, this could increase to 38 block stripes (6 base blocks+16 RUH based block stripes+16 dedicated garbage collection cursor based block stripes).

The difference becomes even more pronounced in real-world scenarios where multiple RUs are approaching capacity simultaneously. For instance, if 4 different RUs in a RG with persistent isolation are simultaneously reaching their capacity limits, the system may need 4 separate reserved block stripes just for parallel garbage collection operations, in addition to the standard free block threshold. Without persistent isolation, these operations could share the same garbage collection resources, requiring fewer reserved blocks.

The free block stripe management component 206 can also track actual usage statistics of each write cursor, identify inactive write cursors, and dynamically reduce the free block threshold based on the identified inactive cursors. The free block stripe management component 206 can monitor the WAF and can adjust the free block threshold to optimize performance based on actual usage patterns.

For example, the free block stripe management component 206 can implement sophisticated usage tracking capabilities that go beyond basic threshold adjustments. The free block stripe management component 206 can continuously monitor the actual usage patterns of each write cursor (e.g., RUH) in the memory sub-system 110, collecting detailed statistics on write frequency, data volume, and access patterns over time. For example, when a host system 120 initially activates 8 write cursors but only actively uses 3 of the 8 write cursors, the free block stripe management component 206 can detect that 5 cursors remain largely inactive. Based on this real-world usage data, the free block stripe management component 206 can dynamically reduce the free block threshold, potentially releasing block stripes that were initially reserved for the inactive cursors back into the general pool of available memory.

The monitoring capabilities of the free block stripe management component 206 extend to analyzing the WAF of the memory device as a key performance indicator. For instance, if the free block stripe management component 206 detects that the WAF has increased beyond an acceptable threshold (such as rising from 1.5 to 2.5) despite having adjusted the free block threshold based on the number of active write cursors, the free block stripe management component 206 can perform further optimizations. In a real-world scenario where a host system 120 initially requests 4 write cursors but primarily uses only 2 of them for 95% of operations, the free block stripe management component 206 can intelligently reduce the free block threshold from 3 extra (for a total of 9) to just 1 extra (for a total of 7), significantly improving overall system efficiency while still maintaining adequate emergency resources for the occasionally used cursors.

This adaptive approach is particularly valuable in enterprise environments where workload patterns change over time. For example, in a database application that uses multiple write cursors during peak hours but fewer during off-peak times, the free block stripe management component 206 can dynamically adjust the threshold throughout the day, optimizing performance based on actual usage rather than static configuration. The memory sub-system 110 might observe that during overnight batch processing, only one primary write cursor handles 90% of the operations, allowing it to temporarily reduce the free block threshold and improve garbage collection efficiency during this period, then readjust when daytime transactional workloads resume with multiple active cursors.

By implementing this intelligent approach to free block threshold management, the free block stripe management component 206 prevents unnecessary over-provisioning that would occur in conventional systems, which might reserve 14 block stripes (6 base blocks+8 additional blocks) even when only one RUH is active. This optimization significantly improves system efficiency by freeing up memory resources that would otherwise be trapped, resulting in better overall performance and reduced write amplification.

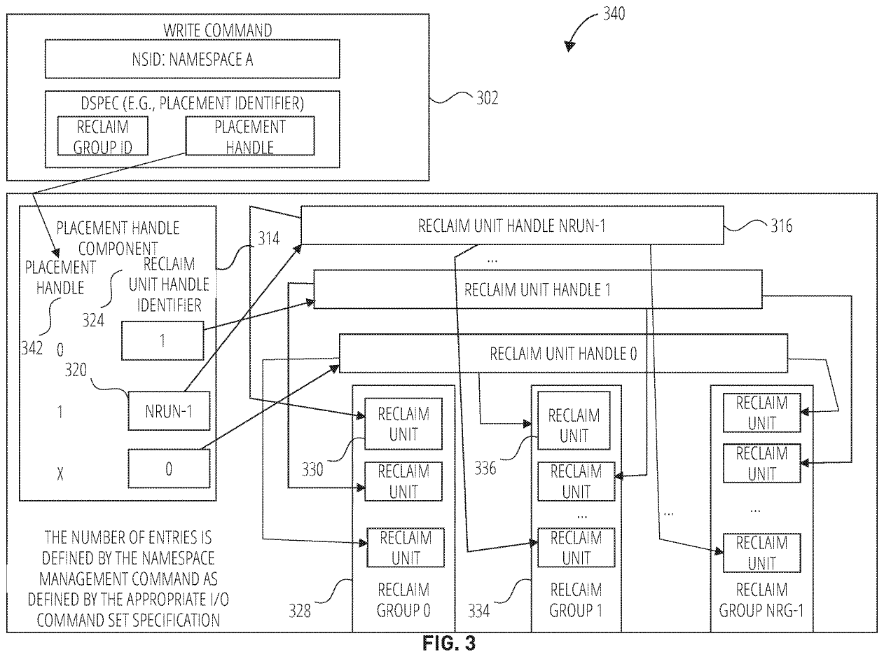

For example, FIG. 3 is a block diagram of an example RG system 340 implementation of the memory sub-system 110 of FIG. 1. The RG system 340 includes a placement handle component 314 that is used to store the map of different groups (e.g., the map stored by the configuration data 204 of FIG. 2). The RG system 340 can receive a write command 302 that specifies at least an RG and/or a placement handle 342. The placement handle component 314 can search the map using the placement handle 342 to identify the RU 324 associated with the specified RG. The RG system 340 can then generate a write pointer 316 (e.g., a RU handle) to write data to the identified RU 324.

As shown in FIG. 3, multiple RGs are defined. For example, the RG system 340 includes a first reclaim group 328 and a second reclaim group 334. The first reclaim group 328 includes a first group of reclaim units 330 (e.g., each of which stores a different block stripe). The second reclaim group 334 includes a second group of reclaim units 336. In some cases, the first reclaim group 328 can represent a single memory die and the second reclaim group 334 represents another single memory die. In some cases, the first reclaim group 328 can represent a first SSD and the second reclaim group 334 represents a second SSD. Each RU in the first group of reclaim units 336 is implemented by a portion of the memory device 130 and memory device 140, such as blocks, planes, superblocks, BSs, pages, and so forth.

Similarly, each RU in the second group of reclaim units 336 is implemented by a different portion of the memory device 130 and memory device 140, such as blocks, planes, superblocks, pages, and so forth. All of the garbage collection operations performed within RUs of an individual RG can be constrained to that individual RG using the RU handle for that individual RG and without using a separate folding cursor. For example, garbage collection operations performed on an individual RU of the first group of reclaim units 330 fold data using only the RUs in the first group of reclaim units 330, and garbage collection operations performed on an individual RU of the second group of reclaim units 336 fold data using only the RUs in the second group of reclaim units 336.

In some examples, the media operations manager 142 of FIG. 2 can program data received from the host system 120 of FIG. 1 into a first reclaim group 328 that includes multiple RUs. Once a given RU is closed, the media operations manager 142 begins programming new data into a new RU. For example, the first reclaim group 328 can program data into the first RU of the reclaim units 330 using a first RU handle 320. Once the first RU has reached a maximum capacity or threshold amount of programmed data, the media operations manager 142 closes the first RU (to prevent additional data from being programmed into the first RU) and opens a new RU and programs new data into the new RU. The different RUs can be referred to as different sets of regions of the first reclaim group 328.

In some cases, the media operations manager 142 begins programming new data into a current RU. Also, the media operations manager 142 can determine that a maximum number of RUs has been reached for the first RG, meaning that additional new RUs cannot be opened. In such cases, the media operations manager 142 can instruct the free block stripe management component 206 of FIG. 2 to perform garbage collection operations on the first reclaim group 328 to free up RUs in the first reclaim group 328.

The free block stripe management component 206 can dynamically adjust the free block threshold based on the actual number of write cursors specified by the host system, rather than reserving block stripes for the maximum possible number of write cursors. When a command to enable FDP is received, the free block stripe management component 206 determines the number of write cursors requested by the host system 120 and sets the free block threshold accordingly, reserving only the necessary number of block stripes. For example, if the host system 120 activates only one write cursor, the free block stripe management component 206 maintains the default threshold (e.g., six free block stripes) without reserving additional blocks. However, if the host system 120 activates multiple write cursors, the free block stripe management component 206 reserves the base blocks (e.g., six free block stripes) and only the additional blocks needed for those specific cursors. This approach prevents unnecessary over-provisioning, optimizes the WAF, and improves overall system efficiency by freeing up memory resources that would otherwise be trapped when reserving for the maximum possible number of write cursors.

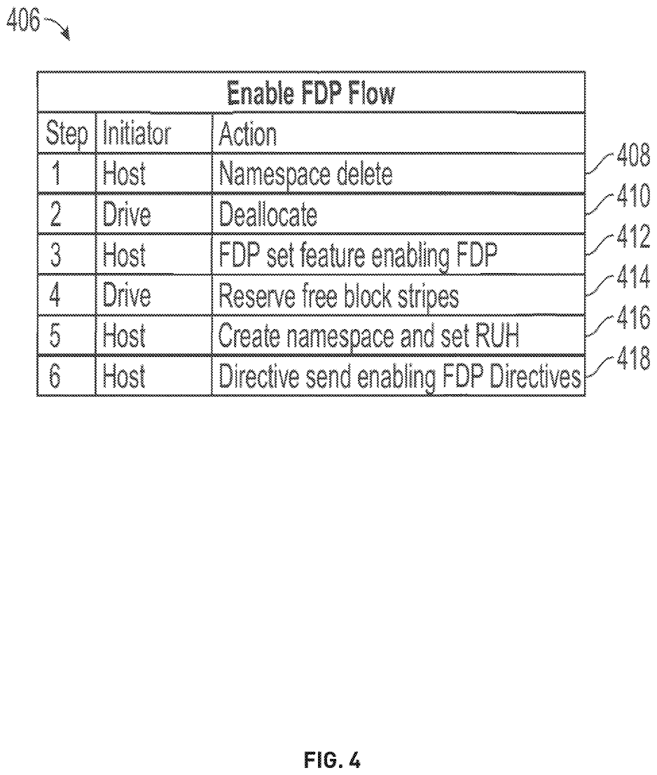

FIG. 4 illustrates an FDP transitioning diagram 406 of operations performed to transition the memory device into an FDP mode, in accordance with some examples.

The FDP transitioning diagram 406 shows a table with six sequential steps that may be executed to enable FDP functionality or the FDP feature of the memory sub-system 110 by the media operations manager 142. In operation 408, the host system 120 initiates the process to enable the FDP feature by issuing a namespace delete command. This operation 408 is important because transitioning to FDP mode can require removing all existing data structures on the memory device 130. Following the namespace deletion, in operation 410, the memory sub-system 110 performs a deallocate operation. This step ensures that all previously allocated memory resources are properly released before the new FDP configuration is established. The deallocate operation prepares the memory device 130 for the subsequent reconfiguration of its physical resources.

At operation 412, the host system 120 issues an FDP set feature command that triggers enabling the FDP functionality. This command contains information that the memory sub-system controller 115 uses to determine how to configure the memory device 130, particularly the number of write cursors (RU handles) that will be supported. At operation 414, the memory sub-system 110 reserves free block stripes (e.g., sets the free block threshold) based on the actual number of write cursors specified in the command from operation 412, rather than reserving for the maximum possible number. This operation 414 can be performed by the free block stripe management component 206 of the media operations manager 142, which dynamically adjusts the free block threshold based on the actual number of write cursors requested.

In operation 416, the host system 120 creates a namespace and sets the RU handles (write cursors). This step is particularly important because it's at this point that the memory sub-system 110 knows exactly how many namespaces will exist and can make informed decisions about resource allocation. The media operations manager 142 can now finalize the number of extra reserved blocks needed based on precise information rather than worst-case assumptions. At operation 418, the host system 120 sends a directive to enable FDP directives, which completes the FDP enablement process. After this step, the memory device 130 is fully configured to operate in FDP mode with the optimized free block threshold.

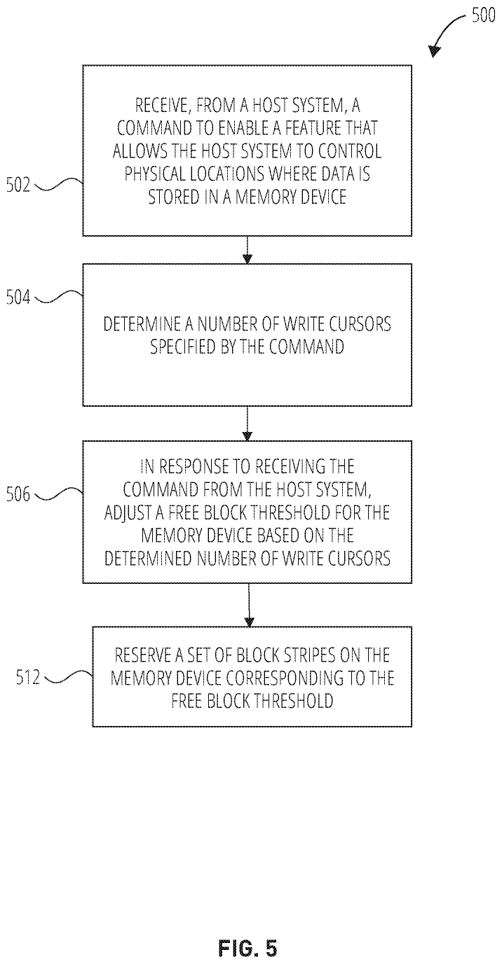

FIG. 5 illustrates a flow diagram 500 of operations performed using the media operations manager 142, in accordance with some examples. The method or process of flow diagram 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method or process of flow diagram 500 is performed by the memory sub-system controller 115, local media controllers 135, and/or subcomponents of the memory sub-system controller 115 and/or local media controllers 135 of FIG. 1. In these examples, the method or process of flow diagram 500 can be performed, at least in part, by the media operations manager 142. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example, other process flows are possible.

Referring now to FIG. 5, the method begins at operation 502 with the media operations manager 142 receiving, from a host system 120, a command to enable a feature that allows the host system to control physical locations where data is stored in a memory device. This operation represents the initial step in the process of enabling FDP functionality, which gives the host system 120 greater control over where data is physically stored in the memory sub-system 110.

At operation 504, the media operations manager 142 determines a number of write cursors specified by the command. This step involves analyzing the command parameters to identify exactly how many write cursors (e.g., RU handles) the host system 120 is requesting to use. The process continues at operation 506, where in response to receiving the command from the host system 120, the media operations manager 142 adjusts a free block threshold for the memory device 130 based on the determined number of write cursors. This adjustment dynamically sets the free block threshold according to actual needs rather than worst-case scenarios. For example, if the host system 120 activates only one write cursor, the memory sub-system 110 maintains the default threshold (e.g., six free block stripes); if multiple write cursors are activated, the memory sub-system 110 calculates the appropriate additional number of free block stripes needed.

Finally, at operation 512, the media operations manager 142 reserves a set of block stripes on the memory device corresponding to the free block threshold. This operation physically allocates the memory resources according to the adjusted threshold, ensuring that only the necessary number of block stripes are reserved. By reserving only what is needed based on the actual number of write cursors, the system prevents unnecessary over-provisioning that would otherwise trap memory resources and increase write amplification.

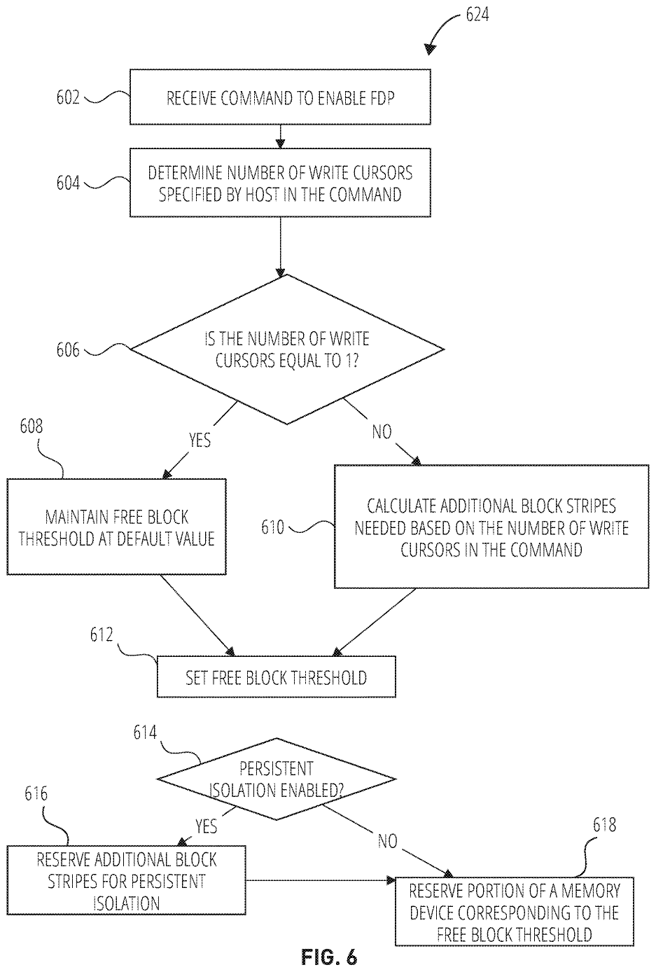

FIG. 6 illustrates a flow diagram 624 of operations performed using the media operations manager 142, in accordance with some examples. The method or process of flow diagram 624 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method or process of flow diagram 624 is performed by the memory sub-system controller 115, local media controllers 135, and/or subcomponents of the memory sub-system controller 115 and/or local media controllers 135 of FIG. 1. In these examples, the method or process of flow diagram 624 can be performed, at least in part, by the media operations manager 142. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example, other process flows are possible.

Referring now to FIG. 6, the method begins at operation 602 with the media operations manager 142 receiving a command to enable FDP for the memory device 130 or memory sub-system 110. This operation represents the initial step in transitioning the memory device 130 (or memory sub-system 110) from a non-FDP mode to an FDP mode, where the host system 120 can control the physical locations where data is stored in the memory device 130.

At operation 604, the media operations manager 142 determines the number of write cursors specified by the host system 120 in the command. This step involves analyzing the command parameters to identify exactly how many write cursors (e.g., RU handles) the host system 120 is requesting to use. This determination is important to optimize resource allocation based on actual requirements rather than worst-case scenarios.

The process then reaches a decision point at operation 606, where the media operations manager 142 evaluates whether the number of write cursors is equal to one. If the answer is “Yes” (the number of write cursors equals one), the flow proceeds to operation 608; if “No” (multiple write cursors are specified), the flow proceeds to operation 610. At operation 608, if only one write cursor is specified, the media operations manager 142 maintains the free block threshold at its default value (e.g., six block stripes). This approach recognizes that the default threshold is already designed to accommodate a single write cursor scenario, so no additional block stripes need to be reserved. Alternatively, at operation 610, if multiple write cursors are specified, the media operations manager 142 calculates the additional number of block stripes needed based on the number of write cursors in the command. For example, if four write cursors are specified, the system can calculate three additional block stripes (one less than the number of write cursors) to be added to the default threshold.

Following either operation 608 or 610, the flow converges at operation 612, where the media operations manager 142 sets the free block threshold according to the previous determinations. This operation finalizes the threshold value that will be used for subsequent memory operations. The process then reaches another decision point at operation 614, where the media operations manager 142 determines if persistent isolation is enabled. Persistent isolation is a feature that prevents garbage collection operations from relocating data from one RU to another RU within a reclaim group, requiring additional resources. If persistent isolation is enabled (the “Yes” path from operation 614), the media operations manager 142 reserves additional block stripes specifically for persistent isolation at operation 616. This may be necessary because persistent isolation requires dedicated garbage collection cursors for each RU, each needing its own reserved block stripe.

If persistent isolation is not enabled (the “No” path from operation 614), the flow proceeds to operation 618, where the media operations manager 142 reserves a portion of the memory device 130 corresponding to the free block threshold that was set in operation 612. This operation physically allocates the memory resources according to the adjusted threshold, ensuring that only the necessary number of block stripes are reserved.

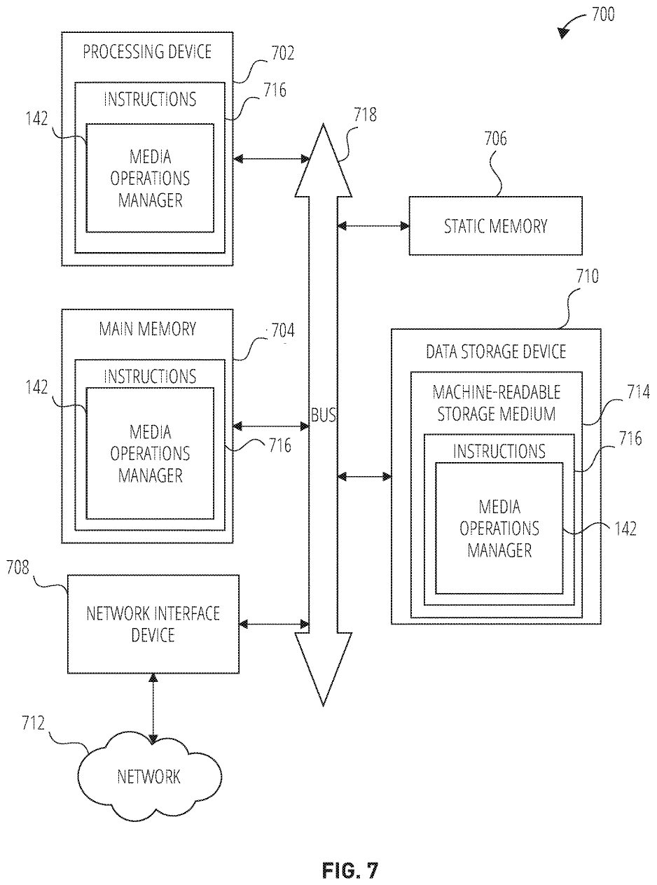

FIG. 7 illustrates an example machine in the form of a computer system 700 within which a set of instructions can be executed for causing the machine to perform any one or more of the methodologies discussed herein. In some examples, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., ROM, flash memory, DRAM such as SDRAM or Rambus DRAM (RDRAM), etc.), a static memory 706 (e.g., flash memory, static random access memory (SRAM), etc.), and a data storage device 710, which communicate with each other via a bus 718.

The processing device 702 represents one or more general-purpose processing devices such as a microprocessor, a central processing unit, or the like. More particularly, the processing device 702 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 702 can also be one or more special-purpose processing devices such as an application-specific integrated circuit (ASIC), a field programmable gate array (FPGA), a digital signal processor (DSP), a network processor, or the like. The processing device 702 is configured to execute instructions 716 for performing the operations and steps discussed herein. The computer system 700 can further include a network interface device 708 to communicate over a network 712.

The data storage device 710 can include a machine-readable storage medium 714 (also known as a computer-readable medium) on which is stored one or more sets of instructions 716 or software embodying any one or more of the methodologies or functions described herein. The instructions 716 can also reside, completely or at least partially, within the main memory 704 and/or within the processing device 702 during execution thereof by the computer system 700, the main memory 704 and the processing device 702 also constituting machine-readable storage media. The machine-readable storage medium 714, data storage device 710, and/or main memory 704 can correspond to the memory sub-system 110 of FIG. 1.

In one example, the instructions 716 include instructions to implement functionality corresponding to providing various memory operations as described herein (e.g., the media operations manager 142 of FIG. 1). While the machine-readable storage medium 714 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.
Example 1. A memory system comprising: a memory device comprising a plurality of memory components organized into a plurality of physical regions; and a processing device, coupled to the memory device, programmed to perform operations comprising: receiving, from a host system, a command to enable a feature that allows the host system to control physical locations where data is stored in the memory device; determining a number of write cursors specified by the command; in response to receiving the command from the host system, adjusting a free block threshold for the memory device based on the determined number of write cursors; and reserving a set of block stripes on the memory device corresponding to the free block threshold.
Example 2. The memory system of Example 1, wherein the memory device comprises a flexible data placement (FDP) compliant storage device.
Example 3. The memory system of Example 2, the operations comprising: determining that the memory device is being operated in a non-FPD mode where the feature is disabled; and in response to determining that the memory device is being operated in a non-FPD mode where the feature is disabled, setting the free block threshold to a default number of free block stripes.
Example 4. The memory system of Example 3, the operations comprising: transitioning the memory device to be operated in an FDP mode where the feature is enabled in response to the command; and determining an amount by which to increase the free block threshold based on the determined number of write cursors.
Example 5. The memory system of Example 4, the operations comprising: deleting all data on the memory device in response to transitioning the memory device to be operated in the FDP mode where the feature is enabled in response to the command.
Example 6. The memory system of any one of Examples 1-5, the operations further comprising: grouping the plurality of memory components into a plurality of reclaim groups (RGs), each RG of the plurality of RGs comprising a subset of reclaim units (RUs), wherein the number of write cursors comprises a number of reclaim unit handles (RUHs).
Example 7. The memory system of Example 6, the operations further comprising: receiving a namespace creation command that specifies the number of write cursors; determining a number of RGs to create based on the command; and allocating the RUs to each RG based on the specified number of write cursors.
Example 8. The memory system of any one of Examples 6-7, the operations further comprising: determining that the number of RUHs in the command is equal to one; and maintaining the free block threshold at a default value in response to determining that the number of RUHs is equal to one.
Example 9. The memory system of any one of Examples 6-8, the operations further comprising: determining that the number of RUHs in the command is greater than one; calculating an additional number of free block stripes to reserve based on the determined number of RUHs; and adjusting the free block threshold to include the additional number of free block stripes.
Example 10. The memory system of Example 9, wherein the additional number of free block stripes includes one less block stripe than the number of RUHs in the command.
Example 11. The memory system of any one of Examples 6-10, the operations further comprising: receiving a subsequent command to create an additional RUH; adjusting the free block threshold based on the subsequent command to create the additional RUH; and reserving an additional block stripe in the memory device corresponding to the adjusted free block threshold.
Example 12. The memory system of any one of Examples 1-11, the operations further comprising: monitoring a write amplification factor (WAF) of the memory device; determining that the WAF exceeds a threshold value; and dynamically adjusting the free block threshold to optimize the WAF based on actual usage patterns of the write cursors.
Example 13. The memory system of any one of Examples 1-12, the operations further comprising: receiving a command to enable persistent isolation for a plurality of reclaim groups (RGs); determining that persistent isolation requires additional reserved block stripes; and further adjusting the free block threshold to accommodate the persistent isolation requirement.
Example 14. The memory system of Example 13, wherein persistent isolation comprises: maintaining data separation between reclaim units (RUs) by preventing garbage collection operations from relocating data from one RU to another RU within a reclaim group (RG); allocating a dedicated garbage collection cursor for each RU in the RG to manage valid data within its respective RU and to perform dedicated garbage collection operations; reserving additional free block stripes beyond the free block threshold corresponding to the determined number of write cursors to support the dedicated garbage collection operations; and maintaining data isolation boundaries between RUs during all memory management operations to ensure data from different write cursors remains physically separated.
Example 15. The memory system of any one of Examples 1-14, the operations further comprising: tracking actual usage statistics of each write cursor; identifying one or more inactive write cursors; and dynamically reducing the free block threshold based on the identified inactive write cursors.
Example 16. The memory system of any one of Examples 1-15, the operations further comprising: determining that the memory device supports a maximum possible number of write cursors; comparing the determined number of write cursors to the maximum possible number; and reserving only a number of free block stripes corresponding to the determined number of writer cursors rather than the maximum possible number.
Example 17. The memory system of any one of Examples 1-16, wherein the memory device comprises a three-dimensional (3D) NAND device.
Example 18. At least one non-transitory machine-readable storage medium comprising instructions that, when executed by a processing device, cause the processing device to perform operations comprising: receiving, from a host system, a command to enable a feature that allows the host system to control physical locations where data is stored in a memory device; determining a number of write cursors specified by the command; in response to receiving the command from the host system, adjusting a free block threshold for the memory device based on the determined number of write cursors; and reserving a set of block stripes on the memory device corresponding to the free block threshold.
Example 19. A method comprising: receiving, from a host system, a command to enable a feature that allows the host system to control physical locations where data is stored in a memory device; determining a number of write cursors specified by the command; in response to receiving the command from the host system, adjusting a free block threshold for the memory device based on the determined number of write cursors; and reserving a set of block stripes on the memory device corresponding to the free block threshold.
Example 20. The method of Example 19, wherein the memory device comprises a flexible data placement (FDP) compliant storage device.

The term “coupled with” generally refers to a connection between components, which can be an indirect communicative connection or direct communicative connection (e.g., without intervening components), whether wired or wireless, including connections such as electrical, optical, magnetic, and the like.

“System data” hereinafter refers to data that is created and/or maintained by the memory sub-system for performing operations in response to host requests and for media management.

“User data” hereinafter generally refers to host data and garbage collection data.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader scope of examples of the disclosure as set forth in the following claims. The specification and drawings are, accordingly, to be regarded in an illustrative sense rather than a restrictive sense.

1. A memory system comprising:
a memory device comprising a plurality of memory components organized into a plurality of physical regions; and
a processing device, coupled to the memory device, programmed to perform operations comprising:
receiving, from a host system, a command to enable a feature that allows the host system to control physical locations where data is stored in the memory device;
determining a number of write cursors specified by the command;
in response to receiving the command from the host system, adjusting a free block threshold for the memory device based on the determined number of write cursors; and
reserving a set of block stripes on the memory device corresponding to the free block threshold.

2. The memory system of claim 1, wherein the memory device comprises a flexible data placement (FDP) compliant storage device.

3. The memory system of claim 2, the operations comprising:
determining that the memory device is being operated in a non-FPD mode where the feature is disabled; and
in response to determining that the memory device is being operated in a non-FPD mode where the feature is disabled, setting the free block threshold to a default number of free block stripes.

4. The memory system of claim 3, the operations comprising:
transitioning the memory device to be operated in an FDP mode where the feature is enabled in response to the command; and
determining an amount by which to increase the free block threshold based on the determined number of write cursors.

5. The memory system of claim 4, the operations comprising:
deleting all data on the memory device in response to transitioning the memory device to be operated in the FDP mode where the feature is enabled in response to the command.

6. The memory system of claim 1, the operations further comprising:
grouping the plurality of memory components into a plurality of reclaim groups (RGs), each RG of the plurality of RGs comprising a subset of reclaim units (RUs), wherein the number of write cursors comprises a number of reclaim unit handles (RUHs).

7. The memory system of claim 6, the operations further comprising:
receiving a namespace creation command that specifies the number of write cursors;
determining a number of RGs to create based on the command; and
allocating the RUs to each RG based on the specified number of write cursors.

8. The memory system of claim 6, the operations further comprising:
determining that the number of RUHs in the command is equal to one; and
maintaining the free block threshold at a default value in response to determining that the number of RUHs is equal to one.

9. The memory system of claim 6, the operations further comprising:
determining that the number of RUHs in the command is greater than one;
calculating an additional number of free block stripes to reserve based on the determined number of RUHs; and
adjusting the free block threshold to include the additional number of free block stripes.

10. The memory system of claim 9, wherein the additional number of free block stripes includes one less block stripe than the number of RUHs in the command.

11. The memory system of claim 6, the operations further comprising:
receiving a subsequent command to create an additional RUH;
adjusting the free block threshold based on the subsequent command to create the additional RUH; and
reserving an additional block stripe in the memory device corresponding to the adjusted free block threshold.

12. The memory system of claim 1, the operations further comprising:
monitoring a write amplification factor (WAF) of the memory device;
determining that the WAF exceeds a threshold value; and
dynamically adjusting the free block threshold to optimize the WAF based on actual usage patterns of the write cursors.

13. The memory system of claim 1, the operations further comprising:
receiving a command to enable persistent isolation for a plurality of reclaim groups (RGs);
determining that persistent isolation requires additional reserved block stripes; and
further adjusting the free block threshold to accommodate the persistent isolation requirement.

14. The memory system of claim 13, wherein persistent isolation comprises:
maintaining data separation between reclaim units (RUs) by preventing garbage collection operations from relocating data from one RU to another RU within a reclaim group (RG);
allocating a dedicated garbage collection cursor for each RU in the RG to manage valid data within its respective RU and to perform dedicated garbage collection operations;
reserving additional free block stripes beyond the free block threshold corresponding to the determined number of write cursors to support the dedicated garbage collection operations; and
maintaining data isolation boundaries between RUs during all memory management operations to ensure data from different write cursors remains physically separated.

15. The memory system of claim 1, the operations further comprising:
tracking actual usage statistics of each write cursor;
identifying one or more inactive write cursors; and
dynamically reducing the free block threshold based on the identified inactive write cursors.

16. The memory system of claim 1, the operations further comprising:
determining that the memory device supports a maximum possible number of write cursors;
comparing the determined number of write cursors to the maximum possible number; and
reserving only the number of free block stripes corresponding to the determined number rather than the maximum possible number.

17. The memory system of claim 1, wherein the memory device comprises a three-dimensional (3D) NAND device.

18. At least one non-transitory machine-readable storage medium comprising instructions that, when executed by a processing device, cause the processing device to perform operations comprising:
receiving, from a host system, a command to enable a feature that allows the host system to control physical locations where data is stored in a memory device;
determining a number of write cursors specified by the command;
in response to receiving the command from the host system, adjusting a free block threshold for the memory device based on the determined number of write cursors; and
reserving a set of block stripes on the memory device corresponding to the free block threshold.

19. A method comprising:
receiving, from a host system, a command to enable a feature that allows the host system to control physical locations where data is stored in a memory device;
determining a number of write cursors specified by the command;
in response to receiving the command from the host system, adjusting a free block threshold for the memory device based on the determined number of write cursors; and
reserving a set of block stripes on the memory device corresponding to the free block threshold.

20. The method of claim 19, wherein the memory device comprises a flexible data placement (FDP) compliant storage device.
